(19) United States
(12) Patent Application Publication
(10) Pub. No.: US 2019/0042276 A1
(43) Pub. Date: Feb. 7, 2019

(54) SERVICE PROCESSING SYSTEM, SERVICE PROCESSING METHOD, AND SERVICE UPDATE METHOD

(71) Applicant: ALIBABA GROUP HOLDING LIMITED, George Town (KY)

(72) Inventor: Zhe ZHU, Hangzhou (CN)

(21) Appl. No.: 16/153,616

(22) Filed: Oct. 5, 2018

Related U.S. Application Data
(63) Continuation of application No. PCT/CN2017/077996, filed on Mar. 24, 2017.

(30) Foreign Application Priority Data
Apr. 6, 2016 (CN) 201610211061.1

(51) Int. Cl. G06F 9/445; H04L 29/08

(52) U.S. Cl. CPC G06F 9/445; H04L 67/32; H04L 67/02

(57) ABSTRACT

A service processing system, a service processing method, and a service update method are provided. The service processing method includes: receiving a service request; extracting service instance routing information included in a URL of the service request; and invoking a service instance corresponding to the service instance routing information based on the service instance routing information to process the service request, wherein each service instance corresponds to at least one piece of service instance routing information.

### CROSS REFERENCE TO RELATED APPLICATION

The present disclosure claims the benefits of priority to International Patent Application number PCT/CN2017/077996, filed Mar. 24, 2017, which claims the benefits of priority to Chinese Patent Application No. 201610211061.1, filed Apr. 6, 2016, both of which are incorporated herein by reference in their entireties.

### TECHNICAL FIELD

The embodiments of the present disclosure relate to communications technologies, and in particular, to a service processing system, a service processing method, and a service update method.

### BACKGROUND

Currently, a number of different types of services are carried on various service platforms, and these services are frequently updated. Therefore, existing service instances on the service platforms often need to be updated. In a conventional service platform, no proper corresponding relationship is established between a service request and a service instance, and service instances are managed and invoked as a whole by a service processing platform. As a result, when a service content item is updated (e.g., a service instance needs to be updated), the entire service platform needs to be redeployed, and a related service process needs to be restarted, which severely affects normal service processes of the service instances on the platform. For example, a Platform-as-a-Service (PaaS) platform updates service content through code delivery and process restarting. That is, when it is detected that content of a service is updated, the PaaS platform stops running a related process of the service and loads a new service instance. After the loading is completed, the PaaS platform needs to restart the related process of the service to perform normal service processing.

Therefore, conventional service processing and updating method has at least the following disadvantages: when a service is updated, a platform needs to stop running a related process of the service until new service content is successfully loaded, which leads to a long service interruption. In addition, there are various risks in a restarting process, which may cause a service interruption and affect stability of service running.

### SUMMARY OF THE DISCLOSURE

The present disclosure provides a service processing system, a service processing method, and a service update method, so as to reduce influences on platform running when service content is updated.

To achieve the foregoing objective, the present disclosure provides a service processing system comprising a service processing server that comprises: a service layer including a plurality of service instances; a routing module configured to run in a routing layer and to: receive a service request; extract service instance routing information included in a URL of the service request; and invoke, in a service layer, a service instance corresponding to the service instance routing information, wherein each of the plurality of service instances corresponds to at least one piece of service instance routing information and is configured to perform service processing corresponding to the service request.

The service processing system may further comprise: a configuration server configured to store relationship information between service instance routing information and a service instance name of each of the plurality of service instances, wherein each service instance name corresponds to at least one piece of service instance routing information, wherein the invoking the service instance corresponding to the service instance routing information includes the routing module being further configured to perform: accessing the configuration server; acquiring a corresponding service instance name based on the service instance routing information and the first corresponding relationship information; and invoking the service instance based on the service instance name.

In the service processing system, the configuration server may be configured to pre-store a second service parameter as a system default parameter and to store relationship information between the second service parameter and the service instance routing information, and the routing module is further configured to: access the configuration server; acquire the second service parameter based on the service instance routing information and the relationship information between the second service parameter and the service instance routing information; send the second service parameter to the service instance; extract a first service parameter from the URL or a data packet of the service request; and send the first service parameter to the service instance.

In the service processing system, the service instance routing information may comprise a service category field and a service route field, the service category field may identify a service category, the routing layer may be provided with a plurality of routing modules, each routing module corresponds to one service category, and the serving layer may comprise a distribution module configured to receive the service request and distribute the service request to a corresponding routing module based on a service category field included in the URL of the service request.

In the service processing system, the service layer may comprise: a first instance running space; and a second instance running space, wherein the routing module is configured to invoke a service instance in the first instance running space, and a service instance in the second instance running space in not invoked by the routing module. In the service processing system, the configuration server may further comprise a monitoring module configured to: monitor a service content code update; and notify the service instance update module, and the service processing server further comprises a service instance update module configured to: generate a new service instance based on new service content code; replace an old service instance running in the first instance running space with the new service instance; and add the old service instance to the second instance running space.

In the service processing system, the service processing server may further comprise a storage layer, service data required in the service processing is stored in the storage layer, and the service instance is configured to invoke the required service data from the storage layer when the service processing is performed. In the service processing system, the service processing server may further comprise a data interface layer arranged between the service layer and the storage layer, the service data of the storage layer has a plurality of data storage formats, and the data interface layer is configured to perform data format conversion between the service layer and the storage layer and to provide a common data access interface for the service instance of the service layer.

The present disclosure further provides a service processing method. The method comprising: receiving a service request; extracting service instance routing information included in a URL of the service request; and invoking a service instance corresponding to the service instance routing information based on the service instance routing information to process the service request, wherein the service instance corresponds to at least one piece of the service instance routing information.

In the service processing method, invoking the service instance corresponding to the service instance routing information comprising: acquiring a corresponding service instance name based on the service instance routing information, wherein each service instance name corresponds to at least one piece of service instance routing information; and invoking the service instance based on the service instance name.

The service processing method may further comprise: extracting a first service parameter from the URL or a data packet of the service request; sending the first service parameter to the service instance; acquiring a pre-stored second service parameter as a system default parameter based on the service instance routing information; and sending the second service parameter to the service instance.

The present disclosure further provides a service processing method performed by a service processing system. The method comprising: receiving, by a routing module of the service processing server, a service request; extracting, by the routing module, service instance routing information included in a URL of the service request; and invoking, by the routing module, a service instance corresponding to the service instance routing information to process the service request, wherein each of a plurality of service instances corresponds to at least one piece of service instance routing information.

In the service processing method performed by the service processing system, invoking the service instance corresponding to the service instance routing information further comprises: accessing, by the routing module, a configuration server; acquiring, by the routing module, a corresponding service instance name based on the service instance routing information and a relationship information between the service instance routing information and a service instance name of each of the plurality of service instances; and invoking, by the routing module, the service instance based on the service instance name.

The service processing method performed by the service processing system may further comprise: pre-storing, by the configuration server, a second service parameter used as a system default parameter; storing, by the configuration server, relationship information between the second service parameter and the service instance routing information; accessing, by the routing module, the configuration server; acquiring, by the routing module, the second service parameter based on the service instance routing information and the second corresponding relationship information; sending, by the routing module, the second service parameter to the service instance; extracting, by the routing module, a first service parameter from the URL or a data packet of the service request; and sending, by the routing module, the first service parameter to the service instance. The service processing method performed by the service processing system may further comprise receiving, by a serving layer of the service processing server, the service request; and distributing, by the serving layer, the service request to a corresponding routing module based on a service category field included in the URL of the service request.

The present disclosure further provides a service update method performed by a service processing system, the method comprising: monitoring a service content update in a configuration server of the service processing system; and notifying a service processing server of the service processing system such that the service processing server generates a new service instance based on the service content update and replaces a corresponding old service instance with the new service instance.

In the service update method, the service processing server replaces the corresponding old service instance with the new service instance by: replacing an old service instance running in a first instance running space of the service processing server with the new service instance; and adding the old service instance to a second instance running space of the service processing server.

The present disclosure further provides a non-transitory computer readable medium that stores a set of instructions that is executable by at least one processor of a computer system to cause the computer system to perform a method for service processing, the method comprising: receiving a service request; extracting service instance routing information included in a URL of the service request; and invoking a service instance corresponding to the service instance routing information based on the service instance routing information to process the service request, wherein the service instance corresponds to at least one piece of the service instance routing information.

In the non-transitory computer readable medium, invoking the service instance corresponding to the service instance routing information comprises: acquiring a corresponding service instance name based on the service instance routing information, wherein each service instance name corresponds to at least one piece of service instance routing information; and invoking the service instance based on the service instance name.

In the non-transitory computer readable medium, the at least one processor of the computer system may cause the computer system to further perform: extracting a first service parameter from the URL or a data packet of the service request; sending the first service parameter to the service instance; acquiring a pre-stored second service parameter as a system default parameter based on the service instance routing information; and sending the second service parameter to the service instance.

In technical solutions of the service processing system, the service processing method, and the service update method of the present disclosure, a direct corresponding relationship is established between a service request of each service and a specific service instance, and in a service request processing process, a service instance is found and invoked based on service instance routing information included in a URL. With such an invocation mechanism, when a specific service is invoked, a specific service instance may be directly located based on URL information in a service request. As such, an invocation relationship between a service request and a service instance is quite clear, and each service is relatively independent, which facilitates service management and deployment. In particular, when service content is updated, only an update operation on a service instance corresponding to the service content is required, others service instances are not affected, and running of the entire service processing system is not affected either.

### BRIEF DESCRIPTION OF THE DRAWINGS

Various other advantages and beneficial effects will become apparent to persons of ordinary skill in the art from detailed descriptions of the following exemplary embodiments. The accompanying drawings are only intended to illustrate the exemplary embodiments and are not construed as a limitation to the present disclosure. Throughout the accompanying drawings, the same components are denoted by the same reference numerals.

FIG. 1 is a flowchart providing an exemplary service processing method, consistent with some embodiments of the present disclosure;

FIG. 2 is a schematic diagram illustrating an exemplary service processing system, consistent with some embodiments of the present disclosure;

FIG. 3 is a schematic diagram illustrating another exemplary service processing system, consistent with some embodiments of the present disclosure;

FIG. 4 is a schematic diagram illustrating another exemplary service processing system, consistent with some embodiments of the present disclosure;

FIG. 5 is a schematic diagram illustrating another exemplary service processing system, consistent with some embodiments of the present disclosure;

FIG. 6 is a schematic diagram illustrating another exemplary service processing system, consistent with some embodiments of the present disclosure;

FIG. 7 is a schematic diagram illustrating another exemplary service processing system, consistent with some embodiments of the present disclosure; and

FIG. 8 is a flowchart providing an exemplary service update method, consistent with some embodiments of the present disclosure.

### DETAILED DESCRIPTION

Exemplary embodiments of the present disclosure are described in further detail below with reference to the accompanying drawings. Although the exemplary embodiments of the present disclosure are shown in the accompanying drawings, it should be understood that the present disclosure may be implemented in various forms and should not be limited by the embodiments set forth herein. Rather, these embodiments are provided so that the present disclosure will be more thoroughly understood, and the scope of the present disclosure can be completely conveyed to those skilled in the art. The exemplary embodiments of the present disclosure are described in detail below with reference to the accompanying drawings.

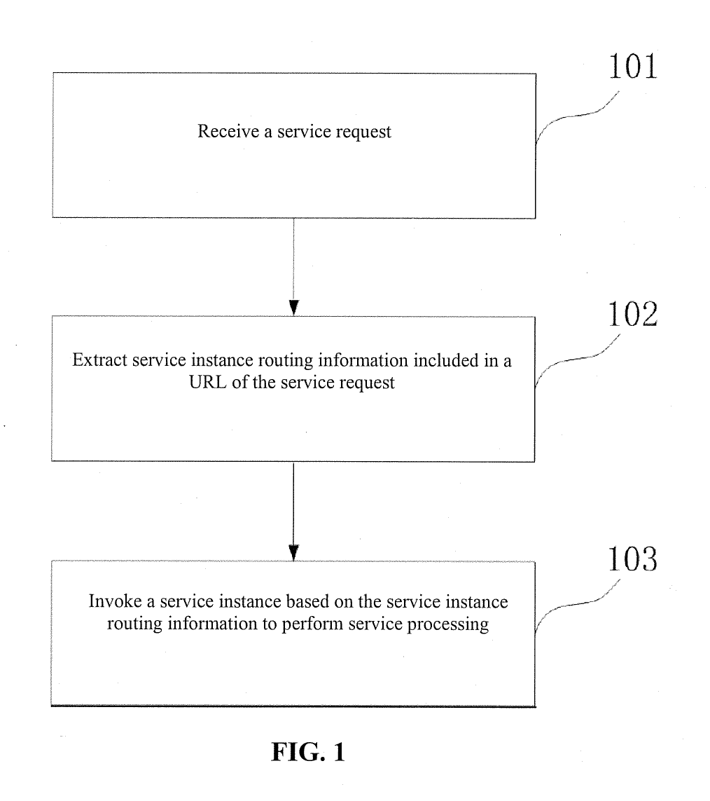

References are now made to FIG. 1, a flowchart providing an exemplary service processing method, consistent with some embodiments of the present disclosure. As shown in FIG. 1, the method comprises steps 101-103.

In step 101, a service request is received.

In step 102, a service instance routing information included in a URL of the service request is extracted. In some embodiments of the present disclosure, field information of a URL is newly designed and defined, and service instance routing information is added to the URL. In some embodiments of the present disclosure, A URL structure may use the following structure: http:{host}/{instancepath}?auth[token], wherein “http” is a network protocol part, “host” is an IP address of a server and a host name, “auth[token]” is a parameter part of a URL, and “instancepath” is service instance routing information. For example, the URL is http://www.test.com/testpay?auth[token]=xxxx&, wherein “testpay” is service instance routing information.

In step 103, a service instance corresponding to the service instance routing information is invoked based on the service instance routing information to process the service request. Corresponding to the foregoing URL structure, a mapping relationship may be pre-established between an “instancepath” and a service instance in a service processing system, so that the service processing system may find the corresponding service instance based on the “instancepath.” For example, in the foregoing illustrated URL, a mapping relationship may be established between the “testpay” and a service instance for payment processing to invoke the service instance for payment processing. Each service instance corresponds to at least one piece of service instance routing information, because from the perspective of service instance design, mutually associated service processing content is generally designed in a service instance, which may utilize system resources more efficiently, and also facilitate service instance management.

Specifically, in an actual program processing process, a service instance may be invoked as long as a name of the service instance is learned. Therefore, in step 103, a corresponding service instance name may be first acquired based on the service instance routing information, and then the service instance is invoked based on the service instance name. Each service instance name corresponds to at least one piece of service instance routing information, and the corresponding relationship may be pre-stored in the service processing system. Preferably, a plurality of service instances running in a service layer are independent of each other, and each have a unique service instance name.

In the foregoing service instance invocation mechanism, a direct corresponding relationship is established between a service request of each service and a specific service instance, and in a service request processing process, a service instance is found and invoked based on service instance routing information included in a URL. With such an invocation mechanism, when a specific service is invoked, a specific service instance can be directly located based on URL information in a service request. As such, an invocation relationship between a service request and a service instance is quite clear, and each service is relatively independent, which facilitates service management and deployment. In particular, when service content is updated, only an update operation on a service instance corresponding to the service content is required, other service instances are not affected, and running of the entire service processing system is not affected either.

In some embodiments of the present disclosure, when the service instance is invoked to perform service processing, a service parameter, for example, a user information parameter, may be used. The service parameters may be included in the URL, or may be included in a data packet of the service request, or may be pre-stored in the service processing system. Therefore, the service processing method may further include a step of sending a service parameter to the service instance. Specifically, there are several cases as follows:
(1) A first service parameter is extracted from the URL and/or the data packet of the service request, and sent to the service instance. The first service parameter may be a parameter carried in the service request, for example, information about a user initiating the service request.
(2) A second service parameter pre-stored as a system default parameter is acquired based on the service instance routing information, and sent to the service instance. In this case, in addition to pointing to the service instance name, the service instance routing information may further point to the system default second service parameter that is used for service processing, so that the second service parameter can also be acquired when the service instance is invoked. The second service parameter may be a system default service parameter. For example, when the service instance has some private data to be encrypted, the second service parameter may be a parameter such as a key. For another example, for a service instance that is not expected to be frequently invoked, a system default parameter is set so that invocation may be performed only pre-determined times within one minute.
(3) The case (1) and the case (2) may be combined. In addition to acquiring the first service parameter from the URL and/or the data packet of the service request, the system default second service parameter is also invoked for the service instance to perform service processing.

The corresponding relationship between service instance routing information, a service instance name, and a second service parameter may be expressed in the following corresponding form, and the corresponding relationship may be stored in the service processing system for service instance invocation and service processing:

TABLE 1

| | | |
|---|---|---|
| Service request 1 | Service routing | Service instance name 1 |
| | information 1 | Second service parameter 1 |
| Service request 2 | Service routing | Service instance name 1 |
| | information 2 | Second service parameter 1 |
| Service request 3 | Service routing | Service instance name 2 |
| | information 3 | Second service parameter 1 |
| Service request 4 | Service routing | Service instance name 2 |
| | information 4 | Second service parameter 2 |
| Service request 5 | Service routing | Service instance name 2 |
| | information 5 | |

It can be seen from Table 1 that a service request is one-to-one corresponding to service routing information. In other words, URLs of different service requests include different service routing information. However, different service requests may be processed by the same service instance. For example, the service request 1 and the service request 2 in the foregoing table are both processed by a service instance corresponding to the “service instance name 1.” In addition, the second service parameter is a system default service parameter and may be preset according to different service requests. Different service requests may correspond to the same second service parameter or may correspond to different second service parameters. For some service requests, for example, the service request 5 in the foregoing table, the system default parameter may not be pre-configured for a system service, and service processing is performed entirely based on a service parameter carried in the service request.

During actual application, a layer of index structure, referred to as a route name in some embodiments, may be further added between a service instance and service instance routing information, for example, as shown in the following Table 2:

TABLE 2

| | | |
|---|---|---|
| Service routing | Route name 1 | Service instance name 1 |
| information 1 | | Second service parameter 1 |
| Service routing | Route name 2 | Service instance name 1 |
| information 2 | | Second service parameter 1 |
| Service routing | Route name 3 | Service instance name 2 |
| information 3 | | Second service parameter 1 |

That is, a route name is first found based on service routing information, and then a service instance name or a second service parameter is acquired based on the route name. During actual application, a configuration server may have a specific data storage and index rule. Therefore, the configuration server may pre-store information such as a route name and a service instance name according to the index rule of the configuration server, and then add a mapping relationship between service routing information and the route name.

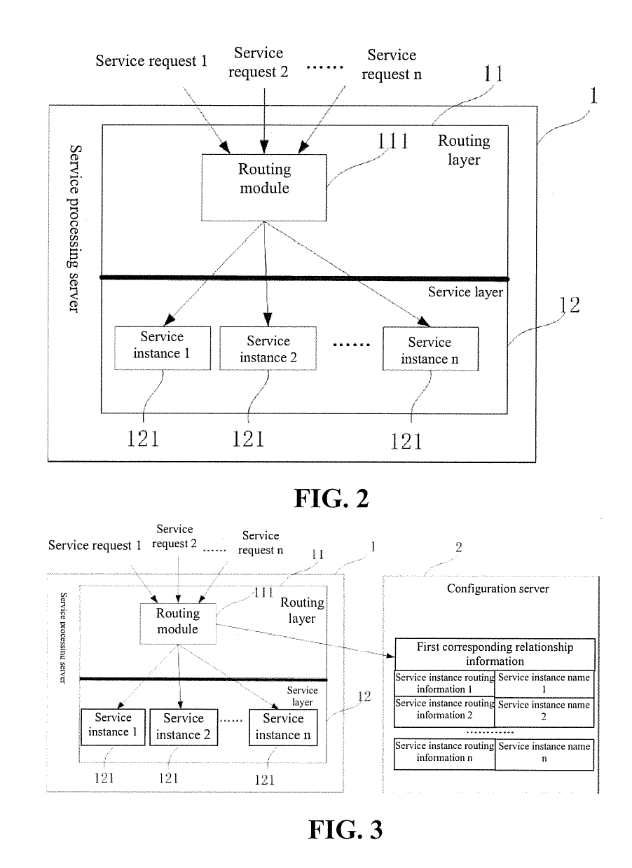

References are now made to FIG. 2, a schematic diagram illustrating an exemplary service processing system, consistent with some embodiments of the present disclosure. As shown in FIG. 2, a service processing system comprises a service processing server 1. Service processing server 1 comprises a routing layer 11 and a service layer 12. A routing module 111 runs in routing layer 11, and a plurality of service instances 121 run in service layer 12.

Routing module 111 is configured to receive a service request, extract service instance routing information included in a URL of the service request, and invoke a service instance among the plurality of service instances 121 (the service instances are numbered 1 to n in the figure) corresponding to the service instance routing information based on the service instance routing information. The invoked service instance may perform service processing corresponding to the service request.

Each service instance among the plurality of service instances 121 corresponds to at least one piece of service instance routing information. That is, a relationship between a service instance and service instance routing information may be a one-to-one or one-to-many relationship. Each service instance may have a function of processing a plurality of different specific services, that is, may be used to process a plurality of different service requests. These service requests may trigger, according to different service parameters used during invocation, the service instance to perform different service processing. The figure only exemplarily shows that n service requests are one-to-one corresponding to n service instances. In some embodiments of the present disclosure, service processing corresponding to the service requests 1 to n in the figure may be performed by less than n service instances.

For example, using an online shopping service processing system as an example, during service instance design, a payment-related function (for example, a total price calculation function and a transfer payment function) may be designed to be completed by a service instance. After a user finishes selecting an item, the user may click a “settle” key. Accordingly, a client terminal may first send a “total price calculation” service request to the service processing system. The service request carries a related service parameter such as information about the selected item. The service processing system invokes, by using the foregoing service method, a payment service instance to calculate a total price, and returns and displays data to the user. Next, after the user clicks a “confirm” key, the client terminal further sends a “transfer payment” service request to the service processing system. The service request carries a user payment-related parameter. The service processing system invokes the payment service instance again to perform transfer payment service processing to complete the entire payment process.

Further, the corresponding relationship between a service instance and service instance routing information may be stored in a configuration server that is separately arranged. References are now made to FIG. 3, a schematic diagram illustrating another exemplary service processing system, consistent with some embodiments of the present disclosure. As shown in FIG. 3, the service processing system in FIG. 2 may further include a configuration server 2. Configuration server 2 stores first corresponding relationship information between service instance routing information and a service instance name of each service instance. Each service instance name corresponds to at least one piece of service instance routing information. A service instance may be invoked as long as a name of the service instance is learned. Therefore, each service instance may be registered with the configuration server, and the first corresponding relationship information between service instance routing information and a service instance name of each service instance is pre-configured. It should be noted that FIG. 3 shows only a one-to-one corresponding relationship between n pieces of service instance routing information and n service instance names. In some embodiments of the present disclosure, in the first corresponding relationship stored in the configuration server, the n pieces of service instance routing information may correspond to less than n service instance names.

With the configuration server 2 arranged, after receiving a service request, routing module 111 may extract service instance routing information included in a URL of the service request, then access configuration server 2, acquire a corresponding service instance name based on the service instance routing information and the first corresponding relationship information, and invoke a service instance in the service layer based on the service instance name to perform corresponding service processing.

In some embodiments of the present disclosure, a service parameter required when the service instance is invoked to perform service processing may be included in the URL or a data packet of the service request, while some system default parameters may be stored in the configuration server and acquired based on the service instance routing information. For example, in FIG. 3, configuration server 2 may pre-store a second service parameter as a system default parameter, and may store second corresponding relationship information between the second service parameter and the service instance routing information. It should be noted that FIG. 3 shows only a one-to-one corresponding relationship between n pieces of service instance routing information and n second service parameters. In some embodiments, the n pieces of service instance routing information may also correspond to less than n second service parameters.

With configuration server 2 arranged, when the system default second service parameter needs to be invoked for the service request, routing module 111 may access configuration server 2, acquire the second service parameter based on the service instance routing information and the second corresponding relationship information, and send the second service parameter to the service instance. In addition, routing module 111 may further extract, as circumstances require, a first service parameter from the URL or the data packet of the service request and send the first service parameter to the service instance.

In an exemplary service processing system, a hierarchical architecture is used. For example, service instances are all arranged in service layer 12, functions for searching for and invoking a service instance are arranged in routing layer 11, and service instance routing information is set in a URL. At the same time, a corresponding relationship between service instance routing information and a service instance is established in the service processing system. Therefore, a specific service instance may be located based on the URL, and service management and deployment are facilitated. For example, when service content is updated, only an update operation on a service instance corresponding to the service content is required, other service instances are not affected, and running of the entire service processing system is not affected either.

Further, independent configuration server 2 is arranged to store first corresponding relationship information between service instance routing information and a service instance name, so that routing module 111 may directly acquire a service instance name to complete invocation. In addition, configuration server 2 may further store a second corresponding relationship between a second service parameter and service instance routing information, so that routing module 111 may also acquire a system default parameter corresponding to a current service request when acquiring the service instance name, and the system default parameter may be directly transferred to the service instance when the service instance is invoked.

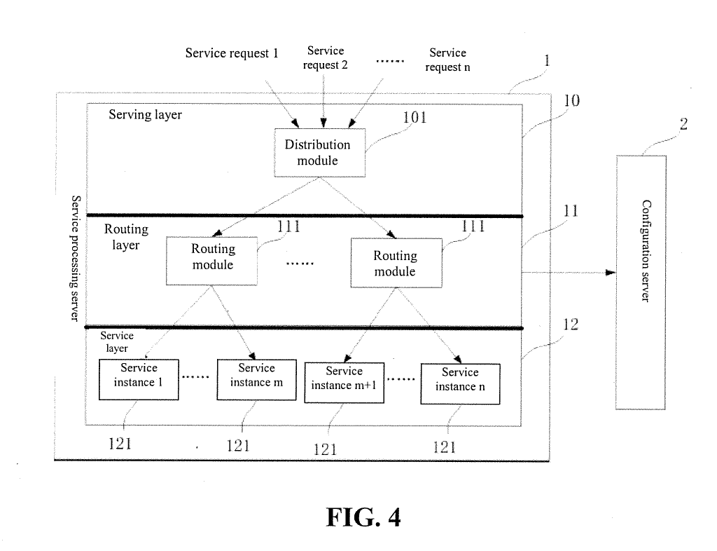

References are now made to FIG. 4, a schematic diagram illustrating another exemplary service processing system, consistent with some embodiments of the present disclosure. As shown in FIG. 4, a serving layer 10 is added to the service processing system of FIG. 3. Correspondingly, the service instance routing information includes a service category field and a service route field. The service category field identifies a service category, the routing layer is provided with a plurality of routing modules, and each routing module may correspond to one service category. For example, the following URL structure may be used:
http:{host}/{app}/{path}?auth[token]
   wherein “http” is a network protocol part, “host” is an IP address of a server and a host name, “auth[token]” is a parameter part of a URL, and service instance routing information includes two parts “{app}/{path},” wherein {app} represents a service category field, {path} represents a route field of a specific service instance belonging to the service category, that is, all routing instances are categorized by using the {app} field, and then a route of a specific service instance is established under each category by using the {path} field. For example, the URL is http://www.test.com/test/pay?auth[token]=xxxx&, wherein “test” is a service category, and “pay” identifies routing information of a payment-related service instance belonging to the service category “test.”

Based on the foregoing structure of the service instance routing information, serving layer 10 may perform service distribution based on the service category field. For example, as shown in FIG. 4, serving layer 10 may include a distribution module 101 configured to receive a service request, and distribute the service request to a corresponding routing module 111 based on a service category field included in a URL of the service request. Accordingly, after receiving the service request, a routing module 111 corresponding to the service request may access configuration server 2, search for a corresponding service instance name based on service instance routing information, that is, “{app}/{path},” and perform subsequent invocation processing. In FIG. 4, two routing modules are exemplarily shown in the routing layer, and after service distribution is performed, the two routing modules respectively correspond to service instances 1 to m and service instances m+1 to n.

In some embodiments of the present disclosure, serving layer 10 may further include a right authentication module configured to perform right authentication on the service request before routing distribution. If the service request does not have a service invocation right, the service request is directly blocked or a denial of reply is returned to a sender of the service request. In addition, serving layer 10 may further include a protocol parsing module configured to perform protocol parsing on the service request. As the uppermost layer of the service processing system, serving layer 10 needs to support a plurality of network protocols to be capable of receiving a service request and forward the service request to a lower layer. For example, the serving layer may support at least common network access protocols such as HTTP and HTTPS.

In some embodiments of the present disclosure, invocation processing is implemented for a service request by using a three-layer hierarchical structure. Service instance routing information is also correspondingly designed, where the service instance routing information is divided into two parts: a service category field that may identify a service category, and a service route field for a route of a specific service instance belonging to the category. With the foregoing architecture design and URL field design, first, a large number of service requests received by the service processing system are distributed at the serving layer based on service categories, and then the distributed service requests are transferred to a routing module in the routing layer for a further routing operation to locate and invoke a specific service instance, while actual service processing is entirely completed by service instances running in the service layer. With the foregoing hierarchical processing mechanism, fast and accurate invocation may be implemented for a service request, and service instance categorization and management are facilitated.

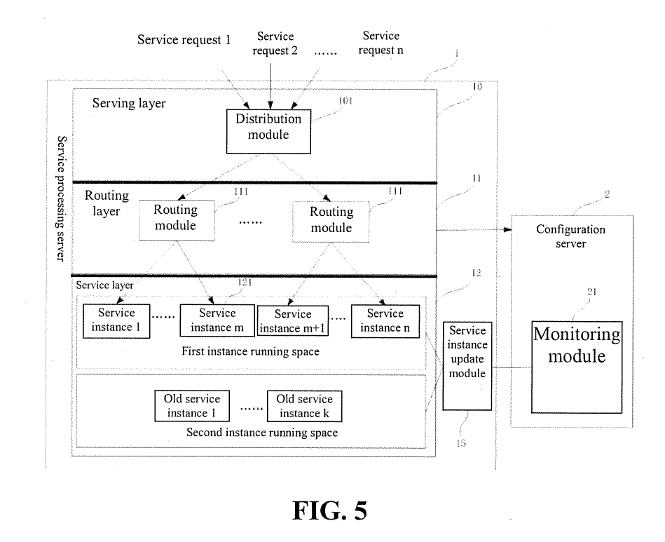

References are now made to FIG. 5, a schematic diagram illustrating another exemplary service processing system, consistent with some embodiments of the present disclosure. To facilitate a smooth service instance update in a service instance update process, as shown in FIG. 5, a service instance running space in service layer 12 may be divided into a first instance running space and a second instance running space. A service instance in the first instance running space may be invoked by the routing module, and a service instance in the second instance running space may not be invoked by the routing module.

Correspondingly, configuration server 2 may further include a monitoring module 21, and service processing server 10 may further include a service instance update module 15. Monitoring module 21 is configured to monitor a service content update and notify service instance update module 15. Service instance update module 15 is configured to generate a new service instance based on new service content, replace a corresponding old service instance running in the first instance running space with the new service instance, and add the old service instance to the second instance running space. The old service instance may continue to run in the second instance running space to perform service processing of a service request received before update, and is removed from the system after service processing is completed. With two instance running spaces arranged in service layer 12, when a service instance is updated, the service instance may be updated and replaced without affecting previous service processing.

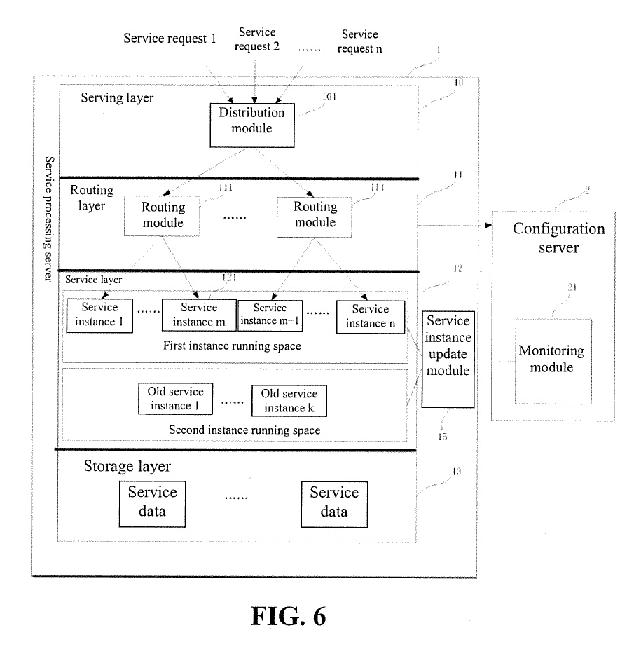

References are now made to FIG. 6, a schematic diagram illustrating another exemplary service processing system, consistent with some embodiments of the present disclosure. As shown in FIG. 6, a storage layer 13 is added to the service processing system of FIG. 5. Service data required in service processing is stored in storage layer 13, and a service instance 121 invokes required service data from storage layer 13 when performing service processing.

By designing structures of the storage layer and the service layer, service processing logic is encapsulated and executed in the service layer, while related service data in service processing is stored in the storage layer, so that service logic is separated from service data, making it more convenient to modify service logic or service data without having much impact on the entire service processing system. During actual application, service processing logic is updated more frequently in the service processing system. Based on the foregoing architecture, if a service content update involves only an update on service processing logic, only a service instance in the service layer needs to be updated, and service data in the storage layer will not be affected.

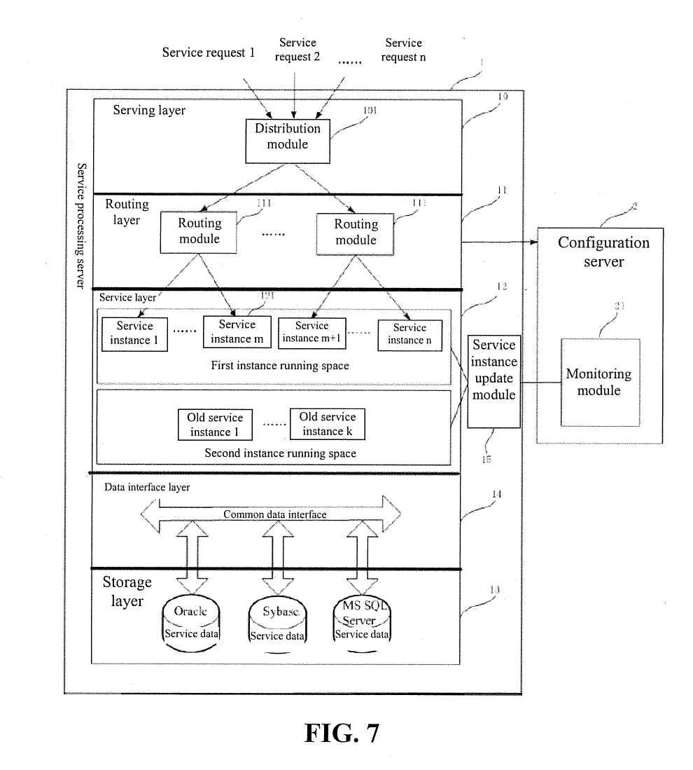

References are now made to FIG. 7, a schematic diagram illustrating another exemplary service processing system, consistent with some embodiments of the present disclosure. To better solve a problem between an underlying data storage format and data invocation of the service layer, the service processing system as shown in FIG. 7 further includes a data interface layer 14 arranged between service layer 12 and storage layer 13. Service data of storage layer 13 has a plurality of data storage formats. Data interface layer 14 is configured to perform data format conversion between service layer 12 and storage layer 13 and provide a common data access interface for the service instance 121 of the service layer.

For example, as shown in FIG. 7, the data in storage layer 13 may use a common data system such as an Oracle™ database system, a Sybase™ database system, or MS SQL Server™. Data interface layer 14 is configured to perform data format conversion between the service layer and the storage layer and provide a common data access interface for the service instance of the service layer.

With the data interface layer arranged, service logic may be thoroughly separated from service data, the storage layer may use different data storage formats to be compatible with different kinds of platform data, and data format conversion may be completed by the data interface layer. In addition, from the perspective of the service layer, service instances running in the service layer are directly oriented to the data interface layer, and may invoke data of the storage layer by using a uniform data interface, thus masking an underlying data difference.

Some embodiments of the present disclosure relate to a service processing method for a service processing system based on FIGS. 3-7. The service processing method is performed on the service processing system. The service processing system at least includes a service processing server. The service processing server includes a routing layer and a service layer. A routing module runs in the routing layer, and a plurality of service instances that perform service processing run in the service layer.

The service processing method comprises: receiving, by a routing module, a service request; extracting service instance routing information included in a URL of the service request; and invoking a service instance corresponding to the service instance routing information based on the service instance routing information to process the service request, wherein each service instance corresponds to at least one piece of service instance routing information.

With such an invocation mechanism, when a specific service is invoked, a specific service instance can be directly located based on URL information in a service request. As such, an invocation relationship between a service request and a service instance is quite clear, and each service is relatively independent, which facilitates service management and deployment.

Further, the service processing system may further include a configuration server. The configuration server stores first corresponding relationship information between service instance routing information and a service instance name of each service instance. Each service instance name corresponds to at least one piece of service instance routing information.

After the configuration server is introduced, the operation of invoking a service instance corresponding to the service instance routing information based on the service instance routing information may further include: accessing, by the routing module, a configuration server; acquiring, by the routing module, a corresponding service instance name based on the service instance routing information and the first corresponding relationship information; and invoking, by the routing module, the service instance based on the service instance name.

Furthermore, the configuration server may pre-store a second service parameter as a system default parameter, and store second corresponding relationship information between the second service parameter and the service instance routing information. Correspondingly, the service processing method may further include: accessing, by the routing module, the configuration server; acquiring, by the routing module, a second service parameter based on the service instance routing information and a second corresponding relationship information; and sending the second service parameter to the service instance; or extracting a first service parameter from the URL and/or a data packet of the service request, and sending the first service parameter to the service instance.

In addition, the service processing server may further include a serving layer, the service instance routing information includes a service category field and a service route field, the service category field identifies a service category, the routing layer is provided with a plurality of routing modules, and each service module corresponds to one service category. Correspondingly, the service processing method may further comprise: receiving, by a serving layer, the service request; and distributing, by the serving layer, the service request to a corresponding routing module based on a service category field included in the URL of the service request.

In some embodiments, invocation processing is implemented for a service request by using a three-layer hierarchical structure. Correspondingly, service instance routing information is also correspondingly designed. First, a large number of service requests received by a service processing system are distributed at a serving layer based on service categories, and then the distributed service requests are transferred to a routing module in a routing layer for a further routing operation to locate and invoke a specific service instance, while actual service processing is entirely completed by service instances running in a service layer. With the foregoing hierarchical processing mechanism, fast and accurate invocation can be implemented for a service request, and service instance categorization and management are facilitated.

Some embodiments of the present disclosure relate to a service update method for a service processing system based on the foregoing embodiments. The service processing system at least includes a service processing server and a configuration server. The service processing server includes a routing layer and a service layer. A routing module runs in the routing layer, and a plurality of service instances that perform service processing run in the service layer. The configuration server stores first corresponding relationship information between service instance routing information and a service instance name of each service instance. Each service instance name corresponds to at least one piece of service instance routing information. The service layer may further include a first instance running space and a second instance running space. A service instance in the first instance running space may be invoked by the routing module, and a service instance in the second instance running space may not be invoked by the routing module.

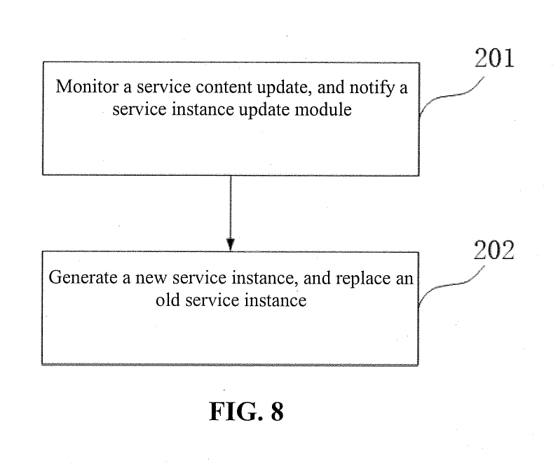

References are now made to FIG. 8, a flowchart providing an exemplary service update method, consistent with some embodiments of the present disclosure. As shown in FIG. 8, the service update method may include steps 201 and 202.

In step 201, a service content update is monitored in the configuration server, and the service processing server is notified. The service content here may be program code or the like for executing specific service content.

In step 202, the service processing server generates a new service instance based on new service content and replaces a corresponding old service instance with the new service instance. The operation of replacing a corresponding old service instance with the new service instance may further include: replacing a corresponding old service instance running in the first instance running space with the new service instance; and adding the old service instance to the second instance running space.

In the service update method, only an update operation on a service instance corresponding to the service content is involved, other service instances are not affected, and running of the entire service processing system is not affected either. In addition, an old service instance is added to a second instance running space that may not be invoked by a routing module and continues service processing, while a new service instance is added to a first instance running space that may be invoked by the routing module, so that the new and old service instances may coexist, thus updating a service instance smoothly.

Persons of ordinary skill in the art may understand that all or some of the steps of the method embodiments may be implemented by one or more processors executing a program instructing relevant hardware. The program may be stored in a computer readable storage medium. When the program is executed, the steps of the method embodiments are performed. The storage medium includes: various media that can store program code, such as a ROM, a RAM, a magnetic disk, or an optical disc.

Finally, it should be noted that the foregoing embodiments are merely intended to describe the technical solutions of the present disclosure, and not to limit the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features therein. These modifications or replacements do not make the essences of the corresponding technical solutions depart from the scope of the technical solutions of the embodiments of the present disclosure.

1-8. (canceled)

9. A service processing method, comprising:
receiving a service request;
extracting service instance routing information included in a URL of the service request; and
invoking a service instance corresponding to the service instance routing information based on the service instance routing information to process the service request,
wherein the service instance corresponds to at least one piece of the service instance routing information.

10. The service processing method according to claim 9, wherein invoking the service instance corresponding to the service instance routing information comprising:
acquiring a corresponding service instance name based on the service instance routing information, wherein each service instance name corresponds to at least one piece of service instance routing information; and
invoking the service instance based on the service instance name.

11. The service processing method according to claim 10, further comprising:
extracting a first service parameter from the URL or a data packet of the service request;
sending the first service parameter to the service instance;
acquiring a pre-stored second service parameter as a system default parameter based on the service instance routing information; and
sending the second service parameter to the service instance.

12-17. (canceled)

18. A non-transitory computer readable medium that stores a set of instructions that is executable by at least one processor of a computer system to cause the computer system to perform a method for service processing, the method comprising:
receiving a service request;
extracting service instance routing information included in a URL of the service request; and
invoking a service instance corresponding to the service instance routing information based on the service instance routing information to process the service request,
wherein the service instance corresponds to at least one piece of the service instance routing information.

19. The non-transitory computer readable medium according to claim 18, wherein invoking the service instance corresponding to the service instance routing information comprises:
acquiring a corresponding service instance name based on the service instance routing information, wherein each service instance name corresponds to at least one piece of service instance routing information; and
invoking the service instance based on the service instance name.

20. The non-transitory computer readable medium according to claim 19, wherein the at least one processor of the computer system causes the computer system to further perform:
extracting a first service parameter from the URL or a data packet of the service request;
sending the first service parameter to the service instance;
acquiring a pre-stored second service parameter as a system default parameter based on the service instance routing information; and
sending the second service parameter to the service instance.

21. A service processing server comprising:
a service layer including a plurality of service instances;
a routing module configured to run in a routing layer and to:
receive a service request;
extract service instance routing information included in a URL of the service request; and
invoke a service instance corresponding to the service instance routing information based on the service instance routing information to process the service request, wherein the service instance corresponds to at least one piece of the service instance routing information.

22. The service processing server of claim 21, wherein the invoking of the service instance corresponding to the service instance routing information comprising:
an acquiring of a corresponding service instance name based on the service instance routing information, wherein each service instance name corresponds to at least one piece of service instance routing information; and
an invoking of the service instance based on the service instance name.

23. The service processing server of claim 22, wherein the service processing server is further configured to perform:
extracting a first service parameter from the URL or a data packet of the service request;
sending the first service parameter to the service instance;
acquiring a pre-stored second service parameter as a system default parameter based on the service instance routing information; and
sending the second service parameter to the service instance.
